(19) United States
(12) Patent Application Publication
(10) Pub. No.: US 2013/0143526 A1
(43) Pub. Date: Jun. 6, 2013

(54) System And Method For Handover Within Heterogeneous Networks

(71) Applicants: Satish Kanugovi, Bangalore (IN); Michael Dolan, Bolingbrook, IL (US)

(72) Inventors: Satish Kanugovi, Bangalore (IN); Michael Dolan, Bolingbrook, IL (US)

(73) Assignees: ALCATEL-LUCENT INDIA LIMITED, Bangalore (IN); ALCATEL-LUCENT USA INC., Murray Hill, NJ (US)

(21) Appl. No.: 13/311,180

(22) Filed: Dec. 5, 2011

(51) Int. Cl. H04W 36/04; H04W 60/00; H04W 12/06; H04W 24/00

(52) U.S. Cl. 455/411; 455/444; 455/435.1

(57) ABSTRACT

The embodiments relate to a system and/or method for handover within a heterogeneous network. The system for handing over a first mobile station between cells includes a small cell and a macro cell. The system includes a small cell gateway configured to serve a plurality of small cells. At least one of the plurality of small cells is a restricted small cell that restricts access to a limited number of mobile stations. The small cell gateway is configured to receive access information for the restricted small cell. The small cell gateway is configured to select a small cell among the plurality of small cells for serving the first mobile station in response to a handover request from a macro base station associated with the macro cell. The small cell gateway does not select the restricted small cell if the first mobile station is not included in the access information.

### BACKGROUND

The wireless industry is experiencing increasing growth in data and service traffic. Smart phones and data devices are demanding more and more from wireless networks. To off-load the traffic in densely populated areas and increase indoor coverage, small cells (e.g., Femto cells) have become a feasible solution. Namely, heterogeneous networks (HetNets) are now being developed, where cells of smaller footprint size are embedded within the coverage area of larger macro cells or at least partially overlapped by the larger macro cells, primarily to provide increased capacity in targeted areas of data traffic concentration. Such heterogeneous networks try to exploit the spatial variations in user (and traffic) distribution to efficiently increase the overall capacity of the wireless network. Those smaller-sized cells are typically referred to as small cells in contrast to the larger and more conventional macro cells.

Optimizing the handoffs for mobile stations between the macro cells and the small cells is a relatively significant issue. For example, during an active handover, the mobile station reports radio-frequency (RF) measurements of pilot signals transmitted from the small cells in the mobile station's vicinity. The macro cell base station selects one of the small cells based on the measurements and initiates the signaling to handover the mobile station to that small cell as the target cell. In a macro cell only deployment, the frequency of reuse of the PN offsets assigned/provisioned to the macro cells is relatively small and hence the target macro cell for an active handover can be uniquely identified by the pilot PN information reported in the measurement message by the mobile station. However, in a heterogeneous network using a number of small cells, the frequency of reuse of the PN offsets is relatively high because the number of unique PN offsets is limited and the number of small cells is usually much higher than the macro cells. Therefore, the target small cell may not be uniquely identified for an active handover. A small cell gateway is typically used to determine the appropriate small cell target from the common PN offset. The gateway typically has to choose the target small cell for the handover among a large number of candidate small cells sharing the common PN offset reported by the device in the measurement message.

The efficiency of handover is critically dependent on the ability of the small cell gateway to reduce the set of candidate small cells from which to search/determine the actual handoff target. Some of the small cells may be a Closed Subscriber Group (CSG), in which case the CSG small cell allows only specific users to connect and avail themselves of the services. The information related to such a set of users is typically called an Access Control List (ACL) of the small cell. Even if a mobile station is able to listen to the pilot signals of the CSG small cell with sufficient quality, the mobile station will not be able to receive service from that CSG small cell if the mobile station is not contained in the ACL information for that CSG small cell. Current standards do not allow the gateway to access to the ACL information.

### SUMMARY

The embodiments relate to a system and/or method for handover within a heterogeneous network.

The system for handing over a first mobile station between cells includes a small cell and a macro cell. The small cell has a coverage area smaller than and at least partially overlapped by a coverage area of the macro cell. The system includes a small cell gateway configured to serve a plurality of small cells. At least one of the plurality of small cells is a restricted small cell that restricts access to a limited number of mobile stations. The small cell gateway is configured to receive access information for the restricted small cell. The access information indicates which mobile stations have access to the restricted small cell. The small cell gateway is configured to select a small cell among the plurality of small cells for serving the first mobile station in response to a handover request from a macro base station associated with the macro cell. The small cell gateway does not select the restricted small cell if the first mobile station is not included in the access information.

In one embodiment, the small cell gateway is configured to receive a measurement response from the restricted small cell in response to a measurement request. The measurement request includes information that enables the restricted small cell to measure a strength of reverse link transmissions for the first mobile station. The measurement response includes the access information.

The small cell gateway may be configured to receive the measurement response if the strength of the measured reverse link transmissions is below a threshold level. Also, the small cell gateway is configured to receive the measurement response regardless of the strength of the measured reverse link transmission. In one embodiment, the measurement response also includes information indicating the strength of the measured reverse link transmissions.

In one embodiment, the small cell gateway is configured to receive the handoff request from the macro base station. The handoff request includes cell identification information. The small cell gateway is configured to determine whether or not a particular small cell among the plurality of small cells can be uniquely identified from the cell identification information. The small cell gateway is configured to select a subset of small cells among the plurality of small cells if the small cell gateway determines that the small cell cannot be uniquely identified. The subset of small cells includes the restricted small cell. The small cell gateway is configured to transmit measurement requests to the subset of small cells. Each measurement request includes information that enables a respective small cell to measure reverse link transmissions for the first mobile station. The small cell gateway is configured to receive measurement responses including a measurement response from the restricted small cell of the subset in response to the measurement requests. The measurement response for the restricted small cell includes the access information. The measurement response for the restricted small cell is received regardless of a strength of the measured reverse link transmissions. The small cell gateway is configured to select the small cell among the plurality of small cells based on the access information and the measurement responses.

In another embodiment, the small cell gateway receives the access information during a startup procedure when the restricted small cell registers with the small cell gateway.

The small cell gateway may receive a registration message from the restricted small cell during the startup procedure. The registration message includes registration information and the access information. In another embodiment, the small cell gateway may receives registration information from the restricted small cell during the startup procedure, and the small cell gateway receives the access information via a signaling message separate from the registration information during the startup procedure.

In another embodiment, the system includes an authentication, authorization, and accounting (AAA) server that is configured to store the access information for the restricted small cell, and the small cell gateway receives the access information from the AAA server.

In another embodiment, the system includes a management system that is configured to manage the plurality of small cells and a database that is configured to store the access information for the restricted small cell. The small cell gateway receives the access information from the database via the small cell management server.

Embodiments include a method for handing over a first mobile station between cells including a small cell and a macro cell. The small cell has a coverage area smaller than and at least partially overlapped by a coverage area of the macro cell. The method includes receiving, by a small cell gateway, access information for a restricted small cell. The restricted small cell restricts access to a limited number of mobile stations. The access information indicates which mobile stations have access to the restricted small cell. The method includes selecting, by the small cell gateway, a small cell among a plurality of small cells for serving the first mobile station in response to a handover request from a macro base station associated with the macro cell. The selecting step does not select the restricted small cell if the first mobile station is not included in the access information.

In one embodiment, the receiving step receives a measurement response from the restricted small cell in response to a measurement request. The measurement request includes information that enables the restricted small cell to measure a strength of reverse link transmissions for the first mobile station. The measurement response includes the access information.

The receiving step may receive the measurement response if the strength of the measured reverse link transmissions is below a threshold level. Also, the receiving step may receive the measurement response regardless of the strength of the measured reverse link transmission. The measurement response may also include information indicating the strength of the measured reverse link transmissions.

The method may further include receiving, by the small cell gateway, the handoff request from the macro base station. The handoff request includes cell identification information. The method includes determining, by the small cell gateway, whether or not a particular small cell among the plurality of small cells can be uniquely identified from the cell identification information, and selecting, by the small cell gateway, a subset of small cells among the plurality of small cells if the small cell gateway determines that the small cell cannot be uniquely identified. The subset of small cells includes the restricted small cell. The method includes transmitting, by the small cell gateway, measurement requests to the subset of small cells. Each measurement request includes information that enables a respective small cell to measure reverse link transmissions for the first mobile station. The method includes receiving, by the small cell gateway, measurement responses including a measurement response from the restricted small cell of the subset in response to the measurement requests. The measurement response for the restricted small cell includes the access information. The measurement response for the restricted small cell is received regardless of a strength of the measured reverse link transmissions. The method includes selecting, by the small cell gateway, the small cell among the plurality of small cells based on the access information and the measurement responses.

In another embodiment, the receiving step receives the access information during a startup procedure when the restricted small cell registers with the small cell gateway.

In another embodiment, the receiving step receives the access information from an authentication, authorization, and accounting (AAA) server. The AAA server stores the access information for the restricted small cell.

In another embodiment, the receiving step receives the access information from a database via a management system. The management system manages a plurality of small cell, and the database stores the access information for the restricted small cell.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the embodiments, and wherein:

FIG. 1 illustrates a wireless communication system according to an embodiment;

FIG. 2 illustrates a method for handing over a mobile station in the wireless communication system using access information received in a measurement response according to an embodiment;

FIG. 3 illustrates a method for handing over the mobile station in the wireless communication system using access information received during a registration procedure according to an embodiment;

FIG. 4 illustrates a method for handing over the mobile station in the wireless communication system using access information received from an AAA server according to an embodiment;

FIG. 5 illustrates a method for handing over the mobile station in the wireless communication system using access information received from a database according to an embodiment.

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes including routines, programs, objects, components, data structures, etc., that perform particular tasks or implement particular abstract data types and may be implemented using existing hardware at existing network elements (e.g., small cells, small cell gateways, small wireless access points, Femto access points, macro base stations, mobile switching centers, mobile stations, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “storage unit” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “mobile station” or “MS” may be synonymous to a user equipment, mobile user, access terminal, mobile terminal, user, subscriber, wireless terminal, terminal and/or remote station, and may describe a remote user of wireless resources in a wireless communication network. Accordingly, an mobile station may be a wireless phone, wireless equipped laptop, wireless equipped appliance, etc.

The term “base station” may be understood as a one or more cell sites, base stations, nodeBs, enhanced NodeBs, access points, and/or any terminus of radio frequency communication. Although current network architectures may consider a distinction between mobile/user devices and access points/cell sites, the example embodiments described hereafter may also generally be applicable to architectures where that distinction is not so clear, such as ad hoc and/or mesh network architectures, for example.

Communication from the base station to the mobile station is typically called downlink or forward link communication. Communication from the mobile station to the base station is typically called uplink or reverse link communication.

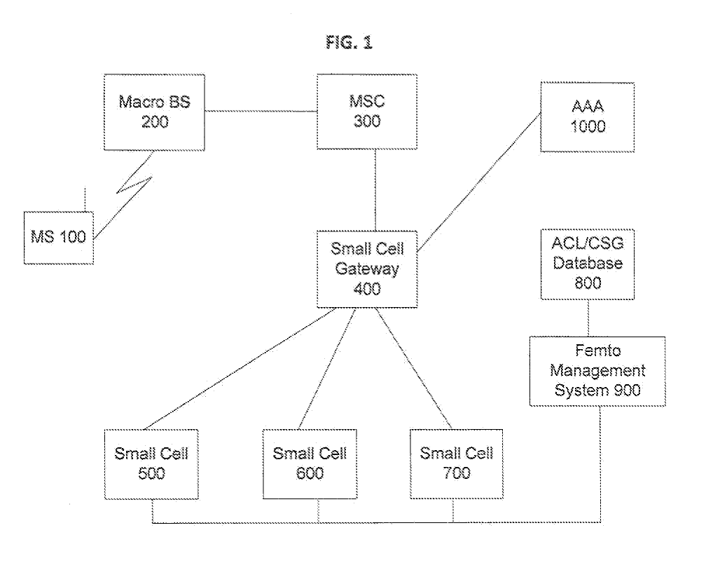

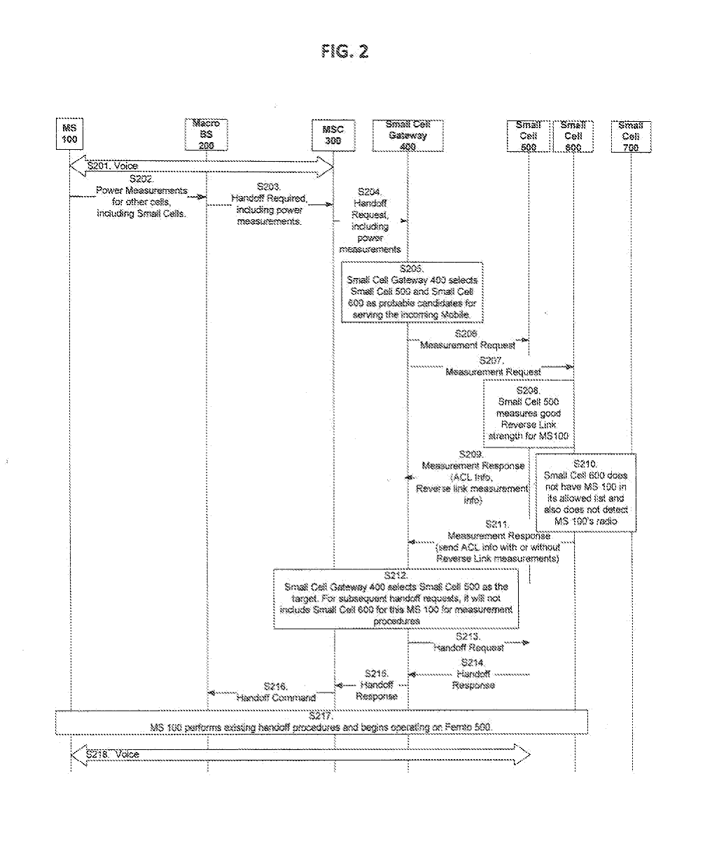

The embodiments provide a system and method for handing over mobile stations between a macro cell base station and a small cell. A small cell gateway, which serves a number of small cells, receives access information (e.g., an Access Control List) for restricted small cells, which are in the vicinity of the mobile station. A restricted small cell is a cell that restricts access to a limited number of mobile stations (e.g., a closed subscriber group). The access information indicates which mobile stations have access to the restricted small cell. According to the embodiments, the small cell gateway is able to reduce the number of candidate small cells based on the access information by not selecting the restricted small cells which do not have the mobile station listed on their access information. FIG. 1 illustrates the overall structure of the wireless communication system, while FIGS. 2-5 illustrate different embodiments of obtaining the access information so that the small cell gateway may optimize the handover procedure.

FIG. 1 illustrates a wireless communication system according to an embodiment. As one example, the wireless communication system may be any type of wireless communication that employs a Code Division Multiple Access (CDMA) Femtocell deployment. For example, FIGS. 1-5 use terminology associated with the CDMA Femto architecture. However, the wireless communication system of the example embodiments can be extended to encompass any type of other wireless architecture such as Wideband Code Division Multiple Access (WCDMA) and Long Term Evolution (LTE), for example, in a manner known to one of ordinary skill in the art. Furthermore, the small cells are not limited to being Femto cells.

Referring to FIG. 1, the wireless communication system includes a heterogeneous network (HetNet), where cells of smaller footprint size (e.g., Femto cells) are embedded within the coverage area of a larger macro cell (e.g., the area served by the macro base station) or at least partially overlapped by the larger macro cell. As used herein, the terminology “cell” refers to the coverage area as well as the base station serving the coverage area. It will be understood that each cell has an associated base station.

The wireless communication system includes a macro base station 200, a mobile switching center (MSC) 300, a small cell gateway 400 that serves a plurality of small cells (e.g., small cell 500, small cell 600, and small cell 700), an authentication, authorization, and accounting (AAA) server 1000, a database 800, and a management system 900. The wireless communication system may include other components that are well known to one of ordinary skill in the art.

The macro, base station 200 has a first coverage area. The macro base station 200 as well as the first coverage area may be referred to as a macro cell. The macro base station 200 provides connectivity for users such as mobile stations 100 that are within the first coverage area. The term “coverage area” may refer to the geographic area served by a base station. The macro base station 200 communicates with the mobile station 100 (and vice versa) via at least one air interface that supports transmission of data between the macro base station 200 and the mobile station 100. Techniques for establishing, maintaining, and operating the air interfaces between the mobile station 100 and the macro base station 200 to provide uplink and/or downlink wireless communication channels between the mobile station 100 and the macro base station 200 are known in the art and in the interest of clarity only those aspects of establishing, maintaining, and operating the air interfaces that are relevant to the present disclosure will be discussed herein.

Also, the wireless communication system includes a number of small cells such as small cell 500, small cell 600 and small cell 700, as shown in FIG. 1. Example embodiments encompass any number and type of small cell. For example, the phrase “small cell” may refer to any relatively small cell or access point, such as a Femto cell, Femto access point (or base station), pico cell, pica access point (or base station), micro cell, micro access point (or base station), metro cell, metro access point (or base station) nano cell, nano access point (or base station), etc.

The small cells may include restricted small cells. A restricted small cell restricts access to a limited number of mobile stations. In one embodiment, the restricted small cell may be a closed subscriber group (CSG). Each restricted small cell has corresponding access information. The access information indicates which mobile stations have access to the corresponding restricted small cell. In one embodiment, the access information may be an Access Control List (ACL). The access information may be stored in the base station of the small cell, the AAA server 1000, and/or the database 800 associated with the management system 900, as further described below.

Each small cell has a coverage area smaller than and at least partially overlapped by the first coverage area of the macro base station 200. Also, each small cell is associated with a coverage area that may or may not be overlapping with another small cell. Further, each small cell has a corresponding small cell base station. The small cell base station and its coverage area may be referred to as a small cell. Additionally, being small cells, the transmit power output and resultant coverage areas of these small cell base stations are smaller than that of the macro cells.

The mobile switching center (MSC) 300 may be any type of conventional MSC for routing data via the wireless communication network. The MSC 300 and the macro base station 200 exchange information according to methods that are well known to one of ordinary skill in the art.

The small cell gateway 400 is any type of server that performs gateway functions for the small cells it serves such as small cell 500, small cell 600 and small cell 700. The small cell gateway 400 encompasses any type of gateway that serves small cells. In the IP Multimedia Subsystem (IMS)/Pre-IMS based 3G-1x voice services architecture, the small cell gateway 400 may be the Femto Convergence Server (FCS). For the IOS based 3G-1x voice services architecture and the High Rate Packet Data (HRPD) data services Femto architecture, the small cell gateway 400 may be the Femto Gateway (FGW) entity. The small cell gateway 400 and the MSC 300 exchange information according to method that are well known to one of ordinary skill in the art.

The AAA 1000 may be any type of server that provides authentication, authorization, and accounting services. The AAA 1000 may include a storage unit that stores user information and/or information related to each small cell, as further explained below. Also, the storage unit of the AAA 1000 may store the access information associated with each small cell served by the small cell gateway 400. The small cell gateway 400 communicates with the AAA 1000 via an interface that is well known in the art.

Also, the wireless communication system may include a management system 900 that includes a database 800. In one embodiment, the management system 900 may be a Femto Management. Server (FMS). Also, in one embodiment, the database 800 may be a closed subscriber group (CSG) database or ACL database. The database 800 may store the access information associated with the restricted small cells. The small cell gateway 400 may communicate with the database 800 via the management system 900 according to methods that are well known to one of ordinary skill in the art.

FIG. 2 illustrates a method for handing over the mobile station 100 in the wireless communication system using access information received in a measurement response according to an embodiment. In this example, the small cell 500, the small cell 600, and the small cell 700 may be restricted small cells having corresponding access information. According to this embodiment, the restricted small cells provide access information to the small cell gateway 400 with respect to the particular mobile station 100 being attempted to be handed-in, even if a strength of the reverse link measurements from the mobile station 100 is below a threshold level, so that the small cell gateway 400 can optimize future handoffs for the mobile station 100. For example, the small cell gateway 400 obtains the access information related to the mobile station 100 from the restricted small cells themselves during a measurement procedure probe.

In step S201, the mobile station 100 establishes a voice call with the macro network served by the macro base station 200 and the MSC 300. In step S202, the mobile station 100 transmits information that indicates power measurements to the macro base station 200. The power measurements indicate the power of the radio signals (e.g., pilots) received from the cells in the neighborhood of the macro base station 200 including any small cells such as small cell 500, small cell 600 and/or small cell 700.

In step S203, based on a comparison of the power of the radio signals from the different cells, as reported in step S202, the macro base station 200 makes a determination that the mobile station 100 will be better served by a cell that is different from the cell that is currently serving the mobile station 100 and transmits a signaling message to the MSC 300 indicating that a handoff is required, according to methods that are well known to one of ordinary skill in the art. The signaling message may include the power measurements and cell identification information that indicates the identity of possible cells to be the target of the handoff.

Based on the power measurements and the cell identification information, the MSC 300 determines the appropriate small cell gateway for the potential cell that can best serve the mobile station 100 for continuing the voice call according to methods that are well known to one of ordinary skill in the art. Therefore, the MSC 300 transmits a handoff request that includes the power measurements and the cell identification information.

In step S204, the small cell gateway 400 receives the handoff request. In step S205, the small cell gateway 400 determines whether or not a particular cell among the plurality of small cells that are served by the small cell gateway 400 can be uniquely identified from the cell identification information. For example, the PN offset of the reported power measurements may identify more than one small cell. In this case, if the small cell cannot be uniquely identified from the cell identification information, the small cell gateway 400 selects a subset of small cells such as small cell 500 and small cell 600 as the potential candidates for the serving the incoming mobile station 100 based on parameters such as the power measurements and other heuristics. The small cell gateway 400 is assumed to initially have no information whether the set of small cells selected as potential candidates can actually serve the mobile station 100 based on their access information.

Next, the small cell gateway 400 transmits a measurement request to each of the potential candidates. The measurement request includes information that enables a respective small cell (e.g., small cell 500 or small cell 600) to measure reverse link transmissions from the mobile station 100. For example, in step S206, the small cell gateway 400 transmits a measurement request to small cell 500. In step S207, the small cell gateway transmits a measurement request to small cell 600.

In step S208, the small cell 500 detects the strength of the reverse link transmissions from the mobile station 100. In other words, the small cell 500 determines if the mobile station 100 is in the vicinity of the small cell 500. In this particular example, the small cell 500 detects that the strength of the reverse link transmissions is above a threshold level. The threshold level may encompass any value that differentiates between a strong signal and a weak signal according to current standards. Typically, the sending of the measurement response to the request from the small cell gateway 400 is suppressed if the strength of the reverse link transmissions from the mobile station 100 at the small cell 500 is below the threshold level unless such a suppression is indicated as not allowed. However, in this particular example, the strength of the reverse link transmissions is above the threshold level, and therefore the small cell 500 transmits the measurement response.

As a result, in step S209, the small cell gateway 400 receives the measurement response including the reverse link measurement information. Also, according to the embodiments, the measurement response may optionally include the access information for the small cell 500. For example, the small cell 500 stores its access information in a storage unit associated with the small cell 500. In this example, the mobile station 100 is included in the access information, which implies that the small cell 500 can provide services to the mobile station 100. The access information indicates which mobile stations have access to the small cell 500.

In step S210, the small cell 600 detects the strength of the reverse link transmissions from the mobile station 100. In other words, the small cell 600 determines if the mobile station 100 is in the vicinity of the small cell 600. In this particular example, the small cell 600 detects that the strength of the reverse link transmissions is below the threshold level. In other words, the small cell 600 detects that the mobile station 100 is not in the vicinity of the small cell 600. As a result, typically, the measurement response to be transmitted to the small cell gateway 400 is suppressed.

However, according to the embodiments, the measurement response for a restricted small cell (e.g., small cell 600) is transmitted to the small cell gateway 400 regardless of the strength of the measured reverse link transmissions. In other words, even if the strength of the reverse link transmission is below the threshold level, a measurement response is transmitted in response to the request. However, the measurement response includes the access information.

In step S211, the small cell gateway 400 receives the measurement response from the small cell 600. In addition, according to this example, although the measured reverse link of the mobile station is below the threshold level, the measurement response may optionally include the measured reverse link signal strength.

Although FIG. 2 illustrates two potential small cells, the embodiments encompass the selecting of any number of probable candidates for the measurement procedures of steps S205-211. The small cell gateway 400 waits for all the chosen small cells to either respond or a configured timer to expire. The performance of the handover depends on how fast the small cell gateway 400 can converge to the suitable small cell, and that convergence in turn depends on the size of the set of the small cells chosen to probe for the suitability to serve the incoming mobile station.

In step S212, based on the access information and the reverse link measurement information, the small cell gateway 400 selects one of the probable candidates as the target cell for handover. For example, after the small cell gateway 400 receives the access information for the respective small cells, the small cell gateway 400 determines whether the incoming mobile station 100 is allowed service on each of the probable candidates based on each received access information. According to the example in FIG. 2, because the mobile station 100 is not present in the access information of the small cell 600, small cell 600 is not selected because it is prohibited from providing services to the mobile station 100 even if the mobile station 100 was in the vicinity of the small cell 600. In this example, the small cell gateway 400 selects small cell 500 because the measurement response from the small cell 500 indicated that the mobile station is in its vicinity and the mobile station 100 is included in the access information for the small cell 500.

Also; the small cell gateway 400 stores the access information for the small cell 500 and the small cell 600 in order to determine whether these restricted small cells can be selected as a target for future handovers involving the mobile station 100 or other mobile stations. For instance, for subsequent handoff requests, the small cell gateway 400 will not include the small cell 600 for the mobile station 100 for the measurement procedure of steps S205-S211. In other words, the small cell gateway 400 determines that the small cell 600 cannot provide service to the mobile station 100 based on the access information and uses this information to avoid selecting the small cell 600 in the potential handoff candidate list in step S205 for subsequent handover requests for the mobile station 100. Also, the small cell gateway 400 may store the access information received from the small cell 500 for use in subsequent handovers to select appropriate candidates in S205.

In step S213, the small cell gateway 400 transmits a handoff request message to the small cell 500 selected as the target small cell for the serving mobile station 100 in step S212.

In step S214, the target small cell 500 sets up radio resources to serve the mobile station 100 and transmits a handoff response message to the small cell gateway 400 indicating successful setup of radio resources at the small cell 500.

In step S215, the small cell gateway 400 transmits a message to the MSC 300, which indicates that the target small cell 500 is ready for providing services to the mobile station 100. In step S216, the MSC 300 transmits a handoff command message to the macro base station 200. The handoff command message includes information that the mobile station 100 can use to connect to the small cell 500 for continuation of the services from the network. This message is further translated to the appropriate air interface signaling by the macro base station 200 and delivered to mobile station 100.

In step S217, the mobile station 100 performs the handoff procedures, as specified in existing standards and established traffic channel with the small cell 500. In step S218, the small cell 500 serves the mobile station 100 for the voice call. As a result, the voice call for the mobile station 100 is thus handed over from the macro base station 200 to the small cell 500.

According to embodiments, the small cell gateway 400 may eliminate those small cells to be included in the set of small cells to be chosen for the signaling procedure to locate the suitable small cell in order to serve the incoming mobile station 100. This may enhance the performance of the handoff because in typical home-Femto deployments most of the small cells are restricted small cells and the access information is utilized in selecting the optimal set of small cells for the measurement procedures.

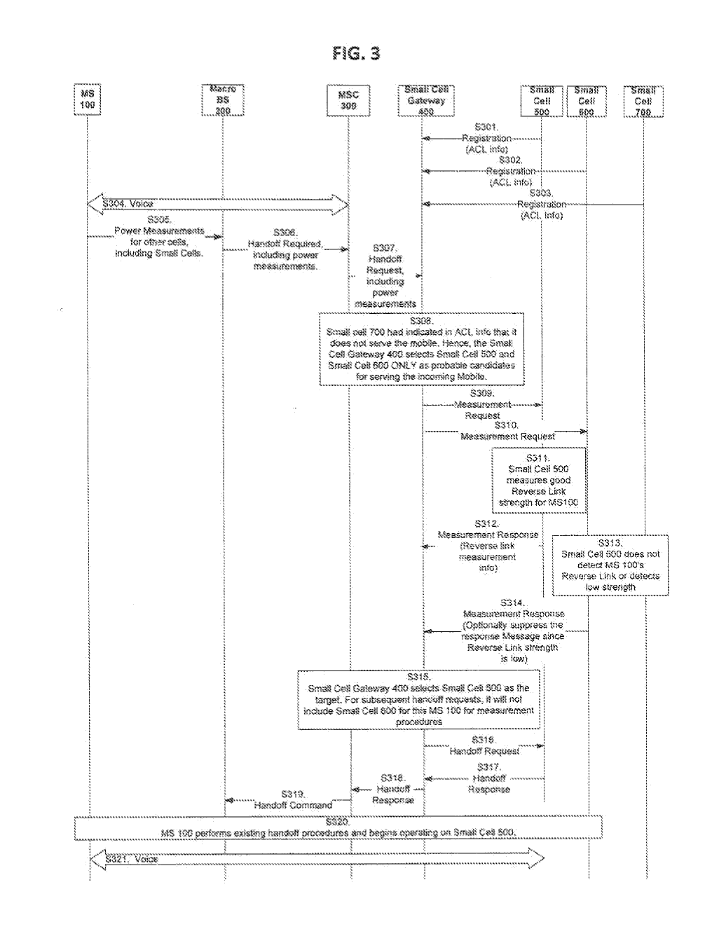

FIG. 3 illustrates a method for handing over the mobile station 100 in the wireless communication system using access information received during a registration procedure according to an embodiment. In this embodiment, the small cell gateway 400 receives the access information from the restricted small cells when the restricted small cells register with the small cell gateway 400 as part of a startup procedure.

Referring to FIG. 3, in step S301, the small cell gateway 400 receives registration information from the small cell 500 when the small cell 500 registers with the small cell gateway 400. According to this embodiment, the registration information includes the access information. As such, the access information is transmitted with the registration information during the startup procedure. Steps S302 and S303 for small cell 600 and small cell 700, respectively, operate in the same manner. Accordingly, the small cell gateway 400 utilizes the access information for the small cell 500, small cell 600, and small cell 700 in order to reduce the number of candidates for the measurement procedure, as explained below.

In another embodiment, instead of the small cell gateway 400 receiving the access information along with the registration information in a same signaling message, a message that is separate from the registration information may be utilized to carry the access information. In other words, the small cell gateway 400 receives the access information via a signaling message separate from the registration information during the startup procedure.

Steps S304-S307 are the same as steps S201-204 of FIG. 2, and therefore the description of steps S304-S307 are omitted for the sake of brevity.

In step S308, the small cell gateway 400 determines whether or not a particular cell among the plurality of small cells that are served by the small cell gateway 400 can be uniquely identified from the cell identification information transmitted in the steps of S306-S307. For example, the PN offset of the reported power measurements may identify more than one small cell. In this case, if the small cell cannot be uniquely identified from the cell identification information, the small cell gateway 400 selects a subset of small cells as the potential candidates for the serving the incoming mobile station 100 based on parameters such as the power measurements and other heuristics. However, according to this embodiment, the small cell gateway 400 also selects (and may reduce) the subset of small cells based on the access information received in steps S301-S302.

For example, the small cell gateway 400 determines whether the mobile station 100 is listed in the access information received in steps S301-S303. In this, particular example, the access information for small cell 700 indicates that the small cell 700 does not serve the mobile station 100. In contrast, the access information for the small cell 500 and the access information for the small cell 600 indicate that they serve the mobile station 100. Therefore, the small cell gateway 400 selects small cell 500 and small cell 600 as probable candidates for serves the incoming mobile station 100, while not selecting small cell 700. As such, the measurement procedure is carried out with respect to only small cell 500 and small cell 600. In other words, the measurement procedure is performed with respect to each small cell of the subset. However, by using the access information, the small cell gateway 400 is able to reduce the number of candidate cells for the handoff procedure.

In step S309, the small cell gateway 400 transmits a measurement request to the small cell 500, and, in step S310, the small cell gateway 400 transmits a measurement request to the small cell 600. Steps S309-S310 are the same as steps S206-S207 of FIG. 2, and therefore the description of steps S309-S310 are omitted for the sake of brevity.

In step S311, the small cell 500 detects the strength of the reverse link transmissions from the mobile station 100. In other words, the small cell 500 determines if the mobile station 100 is in the vicinity of the small cell 500. In this particular example, the small cell 500 detects that the strength of the reverse link transmissions is above the threshold level. Therefore, in step S312, the small cell 500 transmits a measurement response to the small cell gateway 400. The measurement response includes information indicating the strength of the reverse link transmissions.

In step S313, the small cell 600 detects the strength of the reverse link transmissions from the mobile station 100. In this particular example, the small cell 600 detects a weak signal that is below the threshold level. In one embodiment, in step S314, the small cell transmits the measurement response to the small cell gateway 400. Alternatively, in step S314, the small cell 600 may suppress the measurement response.

Steps S315-S321 are the same as steps S212-S218 of FIG. 2, and therefore the description of steps S315-S321 are omitted for the sake of brevity.

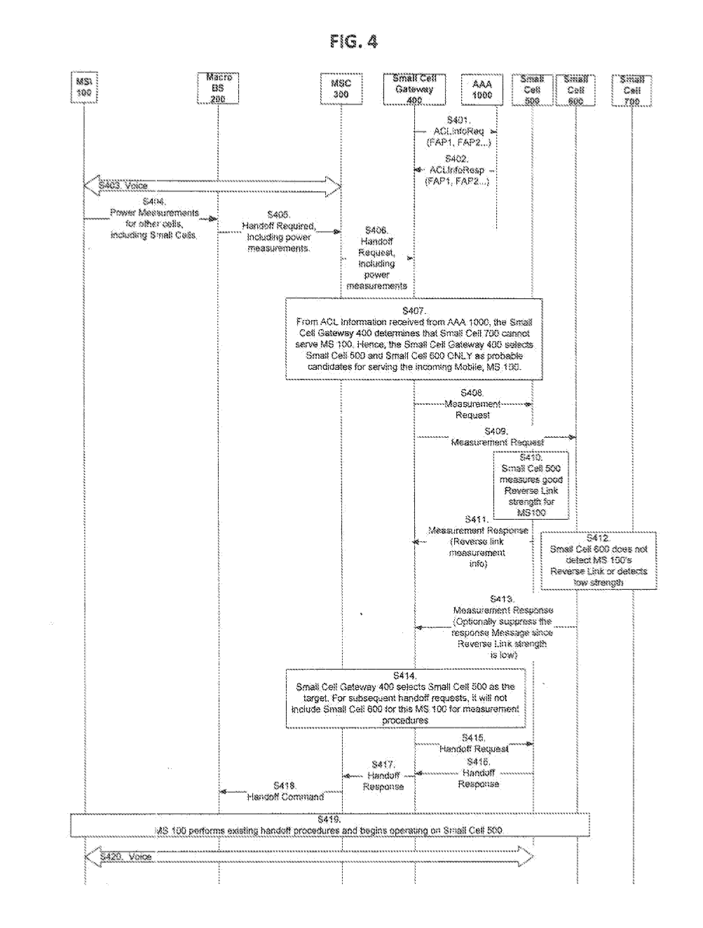

FIG. 4 illustrates a method for handing over the mobile station 100 in the wireless communication system using access information received from an AAA server according to an embodiment. In FIG. 4, the small cell gateway 400 obtains the access information by directly interfacing with the AAA server 1000. Accordingly, the small cell gateway 400 uses the access information to determine whether to select a particular small cell in the set of small cells to probe during the hand-in procedures.

In this embodiment, the AAA server 1000 stores the access information for each of the small cells that is served by the small cell gateway 400. In step S401, the small gateway 400 transmits a request to obtain the access information of its small cells to the AAA server 1000. The small gateway 400 may transmit the request for the access information at a particular time, or periodically. In step S402, the small cell gateway 400 receives a response including the access information for the small cells including small cell 500, small cell 600 and small cell 700 from the AAA server 1000.

Steps S403-S420 are the same as steps S304-S321 of FIG. 3, and therefore the description of steps S403-S420 are omitted for the sake of brevity. For instance, the small cell gateway 400 uses the access information in the same manner as previously described with reference to FIG. 3 in order to determine whether to select a particular small cell in the set of small cells to probe during the hand-in procedures.

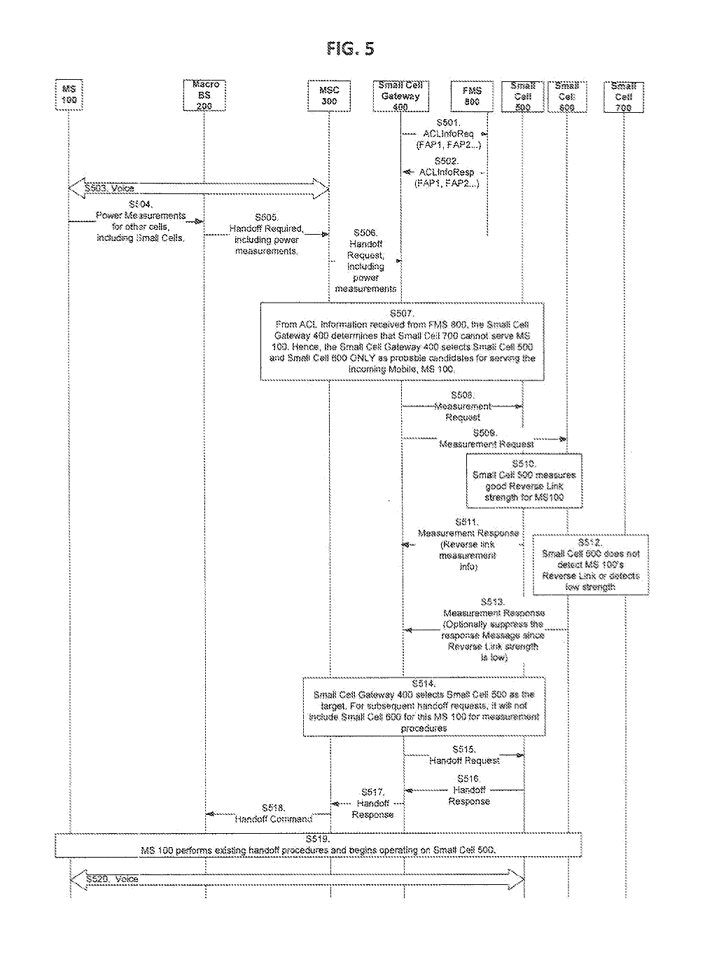

FIG. 5 illustrates a method for handing over the mobile station 100 in the wireless communication system using access information received from a database according to an embodiment. In FIG. 5, the small cell gateway 400 obtains the access information by directly interfacing with the management system 900. Accordingly, the small cell gateway 400 uses the access information to determine whether to select a particular small cell in the set of small cells to probe during the hand-in procedures.

In this embodiment, the database 800 associated with the management system 900 stores the access information for each of the small cells that is served by the small cell gateway 400. In step S501, the small gateway 400 transmits a request to obtain the access information for its small cells to the database 800 via the management system 900. The request to obtain the access information may be transmitted at a particular time, or periodically. In step S502, the small cell gateway 400 receives a response including the access information for the small cells including small cell 500, small cell 600 and small cell 700 from the database 800 via the management system 900.

Steps S503-S520 are the same as steps S304-S321 of FIG. 3, and therefore the description of steps S503-S520 are omitted for the sake of brevity. For instance, the small cell gateway 400 uses the access information in the same manner as previously described with reference to FIG. 3 in order to determine whether to select a particular small cell in the set of small cells to probe during the hand-in procedures.

Variations of the example embodiments are not to be regarded as a departure from the spirit and scope of the example embodiments, and all such variations as would be apparent to one skilled in the art are intended to be included within the scope of this disclosure.

What is claimed:

1. A system for handing, over a first mobile station between cells including a small cell and a macro cell, the small cell having a coverage area smaller than and at least partially overlapped by a coverage area of the macro cell, the system comprising:
a small cell gateway configured to serve a plurality of small cells, at least one of the plurality of small cells being a restricted small cell that restricts access to a limited number of mobile stations,
the small cell gateway configured to receive access information for the restricted small cell, the access information indicating which mobile stations have access to the restricted small cell,
the small cell gateway configured to select a small cell among the plurality of small cells for serving the first mobile station in response to a handover request from a macro base station associated with the macro cell, the small cell gateway not selecting the restricted small cell if the first mobile station is not included in the access information.

2. The system of claim 1, wherein the small cell gateway is configured to receive a measurement response from the restricted small cell in response to a measurement request, the measurement request including information that enables the restricted small cell to measure a strength of reverse link transmissions for the first mobile station, the measurement response including the access information.

3. The system of claim 2, wherein the small cell gateway is configured to receive the measurement response if the strength of the measured reverse link transmissions is below a threshold level.

4. The system of claim 2, wherein the small cell gateway is configured to receive the measurement response regardless of the strength of the measured reverse link transmission.

5. The system of claim 4, wherein the measurement response also includes information indicating the strength of the measured reverse link transmissions.

6. The system of claim 1, wherein
the small cell gateway is configured to receive the handoff request from the macro base station, the handoff request including cell identification information,
the small cell gateway is configured to determine whether or not a particular small cell among the plurality of small cells can be uniquely identified from the cell identification information,
the small cell gateway is configured to select a subset of small cells among the plurality of small cells if the small cell gateway determines that the small cell cannot be uniquely identified, the subset of small cells including the restricted small cell,
the small cell gateway is configured to transmit measurement requests to the subset of small cells, each measurement request including information that enables a respective small cell to measure reverse link transmissions for the first mobile station,
the small cell gateway is configured to receive measurement responses including a measurement response from the restricted small cell of the subset in response to the measurement requests, the measurement response for the restricted small cell including the access information, the measurement response for the restricted small cell being received regardless of a strength of the measured reverse link transmissions,
the small cell gateway is configured to select the small cell among the plurality of small cells based on the access information and the measurement responses.

7. The system of claim 1, wherein the small cell gateway receives the access information during a startup procedure when the restricted small cell registers with the small cell gateway.

8. The system of claim 7, wherein the small cell gateway receives a registration message from the restricted small cell during the startup procedure, the registration message including registration information and the access information.

9. The system of claim 7, wherein the small cell gateway receives registration information from the restricted small cell during the startup procedure, the small cell gateway receives the access information via a signaling message separate from the registration information during the startup procedure.

10. The system of claim 1, further comprising:
an authentication, authorization, and accounting (AAA) server Configured to store the access information for the restricted small cell,
wherein the small cell gateway receives the access information from the AAA server.

11. The system of claim 1, further comprising:
a management system configured to manage the plurality of small cells; and
a database configured to store the access information for the restricted small cell,
wherein the small cell gateway receives the access information from the database via the small cell management server.

12. A method for handing over a first mobile station between cells including a small cell and a macro cell, the small cell having a coverage area smaller than and at least partially overlapped by a coverage area of the macro cell, the method comprising:
receiving, by a small cell gateway, access information for a restricted small cell, the restricted small cell restricting access to a limited number of mobile stations, the access information indicating which mobile stations have access to the restricted small cell; and
selecting, by the small cell gateway, a small cell among a plurality of small cells for serving the first mobile station in response to a handover request from a macro base station associated with the macro cell, the selecting step not selecting the restricted small cell if the first mobile station is not included in the access information.

13. The method of claim 12, wherein the receiving step receives a measurement response from the restricted small cell in response to a measurement request, the measurement request including information that enables the restricted small cell to measure a strength of reverse link transmissions for the first mobile station, the measurement response including the access information.

14. The method of claim 13, wherein the receiving step receives the measurement response if the strength of the measured reverse link transmissions is below a threshold level.

15. The method of claim 13, wherein the receiving step receives the measurement response regardless of the strength of the measured reverse link transmission.

16. The method of claim 15, wherein the measurement response also includes information, indicating the strength of the measured reverse link transmissions.

17. The method of claim 12, further comprising:
receiving, by the small cell gateway, the handoff request from the macro base station, the handoff request including cell identification information,
determining, by the small cell gateway, whether or not a particular small cell among the plurality of small cells can be uniquely identified from the cell identification information,
selecting, by the small cell gateway, a subset of small cells among the plurality of small cells if the small cell gateway determines that the small cell cannot be uniquely identified, the subset of small cells including the restricted small cell,
transmitting, by the small cell gateway, measurement requests to the subset of small cells, each measurement request including information that enables a respective small cell to measure reverse link transmissions for the first mobile station,
receiving, by the small cell gateway, measurement responses including a measurement response from the restricted small cell of the subset in response to the measurement requests, the measurement response for the restricted small cell including the access information, the measurement response for the restricted small cell being received regardless of a strength of the measured reverse link transmissions,
selecting, by the small cell gateway, the small cell among the plurality of small cells based on the access information and the measurement responses.

18. The method of claim 12, wherein the receiving step receives the access information during a startup procedure when the restricted small cell registers with the small cell gateway.

19. The method of claim 12, wherein the receiving step receives the access information from an authentication, authorization, and accounting (AAA) server, the AAA server storing the access information for the restricted small cell.

20. The method of claim 12, wherein the receiving step receives the access information from a database via a management system, the management system manages a plurality of small cell, and the database stores the access information for the restricted small cell.
